(19) United States
(12) Patent Application Publication
(10) Pub. No.: US 2026/0012892 A1
(43) Pub. Date: Jan. 8, 2026

(54) A TERMINAL DEVICE, A SYSTEM AND A METHOD FOR ENERGY EFFICIENT POSITIONING FOR REDUCED CAPACITY DEVICES

(71) Applicant: Nokia Technologies Oy, Espoo (FI)

(72) Inventors: Halit Murat GÜRSU, Munich (DE); Ahlem KHLASS, Massy (FR); Diomidis MICHALOPOULOS, Munich (DE)

(21) Appl. No.: 19/129,059

(22) PCT Filed: Nov. 8, 2023
(86) PCT No.: PCT/EP2023/081151

§ 371 Date: May 12, 2025

(30) Foreign Application Priority Data
Nov. 23, 2022 (FI) 20226046

(51) Int. Cl. H04W 52/02; H04B 17/318

(52) U.S. Cl. CPC H04W 52/0245; H04B 17/328; H04W 52/028

(57) ABSTRACT

A terminal device including at least one processor, and at least one memory including computer program code, wherein the at least one memory and the computer program code are configured, with the at least one processor, to cause the terminal device to be configured to pause or stop providing positioning reports when a relaxation state is detected.

### FIELD

The following exemplary embodiments relate to wireless communication.

### BACKGROUND

Existing terminal device positioning schemes persist even in case the terminal device is shown to become stationary, especially for reduce capacity terminal devices and at least for a limited time duration for energy efficiency. Such temporal suspension would be beneficial for the network since it would reduce the unnecessary signalling overhead associated with repeating the same measurement reports from a stationary location.

### SUMMARY

The scope of protection sought for various exemplary embodiments is set out by the claims. The exemplary embodiments and features, if any, described in this specification that do not fall under the scope of the claims are to be interpreted as examples useful for understanding various exemplary embodiments.

According to an aspect, an energy efficient terminal device assisted positioning measurements and reporting for stationary terminal devices. The terminal device is configured for pausing or stopping positioning reference signal (PRS) measurement with respect to stationarity detection.

According to an aspect, the terminal device is configured for one last PRS reporting with respect to stationarity detection before applying Radio Resource Management (RRM) relaxation.

According to an aspect, the configuration is provided to the terminal device over system information broadcast (i.e. positioning relaxation is indicated for each positioning accuracy) or via dedicated signalling.

According to an aspect, the terminal device pauses or stops the periodic positioning reports once the stationarity is detected. This may be extended by using a timer-based approach. The terminal device stops sending periodic positioning report, as such the network entity, can detect that terminal device has paused the positioning reports through a timer. The timer value could be set according to the periodicity of the positioning report.

According to an aspect, the terminal device resumes or restarts the periodic positioning reports once the non-stationarity is detected.

According to an aspect, the terminal device resumes the periodic positioning reporting using the previous configuration.

According to an aspect, the network provides a new positioning reporting configuration to be used after a pause.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates a signalling diagram according to an exemplary embodiment;

FIG. 3 illustrates a signalling diagram according to an exemplary embodiment;

FIG. 4 illustrates a signalling diagram according to an exemplary embodiment;

FIG. 5 illustrates a signalling diagram according to an exemplary embodiment;

### DETAILED DESCRIPTION

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. A person skilled in the art will realize that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

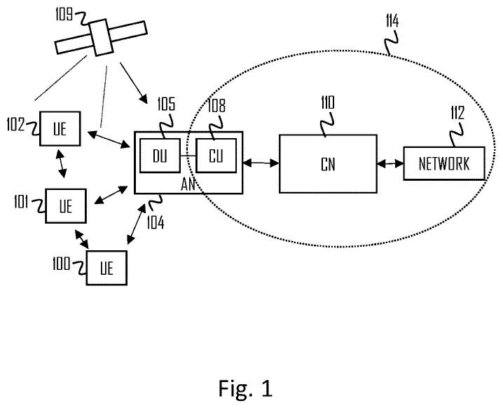

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows terminal devices or user devices 100, 101, and 102 configured to be in a wireless connection on one or more communication channels in a cell with an access node (such as (e/g)NodeB) 104 providing the cell. (e/g)NodeB refers to an eNodeB or a gNodeB, as defined in 3GPP specifications. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used not only for signalling purposes but also for routing data from one (e/g)NodeB to another. The (e/g)NodeB is a computing device configured to control the radio resources of communication system it is coupled to. The NodeB may also be referred to as a base station, an access point, an access node, or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (terminal devices) to external packet data networks, or mobile management entity (MME), etc.

The user device (also called terminal device, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and typically fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 105) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 109 in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto-or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

5G is designed to address a wide range of use cases, such as the enhanced mobile broadband (eMBB), ultra-reliable low latency communication (URLLC), and massive machine-type communication (mMTC), with different requirements in terms of data rates, latency, reliability, coverage, energy efficiency, and connection density. mMTC may cover cellular low power wide area (LPWA) technologies such as narrowband internet of things (NB-IoT) and long term evolution for machine type communication (LTE-MTC). Yet another use case for 5G is time-sensitive communication (TSC). However, in between these use cases, there are also some mid-range use cases, such as industrial wireless sensor networks, video surveillance, and wearables (e.g., smart watches, rings, eHealth-related devices, personal protection equipment, medical monitoring devices, etc.). In other words, the requirements of these mid-range use cases may be higher than LPWA, but lower than eMBB and URLLC. In order to efficiently serve these mid-range use cases, the 3rd generation partnership project (3GPP) has introduced reduced capability (RedCap) devices in NR Release 17 (Rel-17) and considered further complexity reduction techniques in NR Release 18 (Rel-18). RedCap devices may also be referred to as RedCap terminal devices, NR-Lite devices, or NR-Light devices.

RedCap devices may have lower complexity (e.g., reduced bandwidth and number of antennas), a longer battery life, and a smaller form factor than non-RedCap devices, such as eMBB terminal devices, URLLC terminal devices and other legacy terminal devices. For example, a RedCap device may comprise 1 receiver branch and 1 transmitter branch (1Rx/1Tx), or 2 receiver branches and 1 transmitter branch (2Rx/1Tx), in both frequency range 1 (FR1) and frequency range 2 (FR2). RedCap devices may support all FR1 and FR2 bands for frequency-division duplexing (FDD) and time-division duplexing (TDD).

Industrial wireless sensors and actuators are one example of RedCap devices. It may be desirable to connect these sensors and actuators to 5G radio access and core networks in order to improve flexibility, enhance productivity and efficiency, and improve operational safety. Industrial wireless sensors may comprise, for example, pressure sensors, humidity sensors, thermometers, motion sensors, and/or accelerometers, etc. Industrial wireless sensor network use cases include not only URLLC services with very high requirements, but also relatively low-end services requiring small device form factors and/or being completely wireless with a battery life of several years. These low-end services may be provided by RedCap devices. Industrial wireless sensors associated with low-end services may also have the following use-case-specific requirements: communication service availability is at least 99.99%, end-to-end latency is less than 100 ms, and the reference bit rate is less than 2 Mbps (potentially asymmetric, e.g., UL heavy traffic) for all use cases and the device is expected to be mostly stationary. For safety-related sensors, the latency requirement may be more stringent, for example 5-10 ms.

Video surveillance cameras are another example of RedCap devices. The deployment of surveillance cameras may be beneficial, for example, for smart city use cases, as well as for factories and industries, in order to monitor and control city/factory resources more efficiently. The following requirements may apply for video surveillance use cases: the reference economic video bitrate is 2-4 Mbps, latency is less than 500 ms, and the reliability is at least 99%-99.9%. High-end video applications (e.g., for farming) may require a video bitrate of 7.5-25 Mbps. It is noted that the traffic pattern may be dominated by UL transmissions.

Wearables, such as smart watches, rings, eHealth-related devices, personal protection equipment, and/or medical monitoring devices, are another example of RedCap devices. One characteristic for this use case is that the device is small in size. The following requirements may apply for wearables: the reference bitrate for smart wearable applications may be 5-50 Mbps in downlink (DL) and 2-5 Mbps in uplink (UL), and the peak bit rate of the device may be higher, for example up to 150 Mbps for DL and up to 50 Mbps for UL. In addition, the battery of the wearable device should last multiple days (e.g., up to 1-2 weeks).

For example, terminal device energy consumption may be reduced by reducing the terminal device measurement frequency such that the measurements are performed less frequently. Optimizing energy consumption of terminal devices through reduced measurement frequency can be investigated in two branches. The first branch is mobility-related measurements, and the second branch is user plane-related measurements. Radio resource management (RRM) relaxation investigates the mobility-related measurements. RRM relaxation may also be referred to as relaxed monitoring or relaxed measurement. RRM relaxation comprises two components: RRM relaxation trigger, and RRM measurement relaxation.

The RRM relaxation trigger comprises one or more criteria, either configured to the terminal device or acquired by the terminal device from the serving cell, that are used to initiate RRM measurement relaxation. In NR Release 16 (R16), two RRM relaxation triggers, or criteria, have been specified for the terminal device: a low-mobility criterion, and a not-at-cell-edge criterion.

The low-mobility criterion aims to identify a terminal device in a low mobility state. In order for the low-mobility criterion to be fulfilled, the reference signal received power (RSRP) of the serving cell, denoted as RSRPrx, should meet the following condition within a time period of TSearchDeltaP:

$$( RSRPrxRef - RSRPrx ) < RSRPSearchDeltaP , \qquad ( 1 )$$

where RSRPrx is the current RSRP value of the serving gNB, and RSRPrxRef is a reference RSRP value that may be updated in three different ways. Firstly, RSRPrxRef may be updated to the RSRP value of the serving gNB after selecting or reselecting a new gNB. Secondly, RSRPrxRef may be updated to the new RSRP value, when the terminal device is moving closer to the cell center, i.e., (RSRPrx−RSRPrxRef)>0. Thirdly, if the relaxed measurement criterion has not been met for TSearchDeltaP, the terminal device may set the value of RSRPrxRef to the current RSRPrx value. RSRPSearchDeltaP is a parameter configured to the terminal device to monitor the received signal variation. The values of RSRPSearchDeltaP and TSearchDeltaP can be used to define the mobility level of the terminal device.

The not-at-cell-edge criterion aims to detect whether or not the terminal device is at the cell edge of the serving cell. If the not-at-cell-edge criterion is fulfilled, then it may mean that the terminal device is not at the cell edge of the serving cell. In order to detect whether the terminal device is at the cell edge or not, the terminal device may compare the received signal level against a threshold as follows:

$$RSRPrx > RSRPSearchThresholdP , \qquad ( 2 )$$

where RSRPrx is the current RSRP value of the serving gNB, and RSRPSearchThresholdP is the RSRP threshold set for the not-at-cell-edge criterion. The not-at-cell-edge criterion is fulfilled, when RSRPrx is above the threshold RSRPSearchThresholdP (i.e., the terminal device is not at the cell edge).

A given terminal device may be configured to monitor at least one of the RRM relaxation triggers. The network may configure the at least one trigger (i.e., either the low-mobility criterion or the not-at-cell-edge criterion, or both) to the terminal device independently. In case the RRM relaxation is triggered with respect to its configuration, the terminal device may apply RRM measurement relaxation.

There are multiple ways to relax the RRM measurements, such as the cell to relax (e.g., whether to relax the serving cell or a neighbour cell), and how frequently to measure the relaxed cell (i.e., the measurement periodicity for the relaxed cell). In other words, in case the RRM relaxation is triggered, the terminal device may adjust the measurement periodicity for the serving cell and/or a neighbour cell in order to perform the RRM measurements less frequently. Relaxed measurements with longer intervals (scaling factor) can be configured. For example, the terminal device may stop the RRM measurements for up to 1 hour upon triggering the RRM relaxation.

In NR Release 17, the RRM relaxation framework is expected to be extended for RedCap devices, considering a new relaxation trigger called stationarity instead of low mobility. This stationarity relaxation trigger is expected to be used to enable longer RRM relaxation compared to NR Release 16.

Positioning relates to the process of calculating the location of a terminal device, which is referred to as the target the terminal device. There are two main positioning modes, namely terminal device-assisted positioning (where the calculation of the terminal device location takes place at the network side) and terminal device-based positioning (where the calculation of terminal device location takes place at the terminal device side). This disclosure focuses on terminal device-assisted positioning of RedCap terminal devices, since terminal device-assisted positioning concept is compatible with Redcap terminal devices and of interest for the intended use cases.

The positioning procedure involves signaling exchange between the terminal device and the network for calculating and updating the terminal device's location. This is detailed in the LTE positioning protocol (LPP).

To account for monitoring the location of mobile terminal devices, the LPP protocol includes periodic positioning reporting. This allows the positioning procedure to be repeated in certain periodic time intervals, leading to location updates of the target terminal device.

The periodicity of reporting is configured by the network depending on the application, such that applications with highly mobile terminal devices are associated with shorter periodicity values than cases with lower mobility. However, there is no consideration on detecting stationarity on terminal devices-thereby reducing such periodicity to zero where applicable, which sheds light onto the problem of this invention as described in the ensuing section.

According to an embodiment, there is a terminal device comprising at least one processor, and at least one memory including computer program code, wherein the at least one memory and the computer program code are configured, with the at least one processor, to cause the terminal device to be configured to pause or stop positioning reference signal (PRS) measurements and providing positioning reports, when a relaxation state is detected, and to provide information to a radio access network that the terminal device has paused or stopped providing positioning reports. The terminal device may be configured to receive, from the radio access network, a first threshold value, which is used to determine the relaxation state. If the reference signal received power (RSRP) measurement has changed less than the first threshold value from the previous RSRP measurement, the terminal device may detect a relaxation state, and that the terminal device is stationary. This criterion aims to identify that the terminal device is at low mobility state. The RSRP of the serving cell, RSRPrx, should meet within a period of search interval the criteria in Equation 1, where RSRPrx is the current RSRP of the serving gNB, and RSRPrxRef is a reference value RSRP value that is updated in three different ways. The search interval may be configured by the serving cell. Firstly, it is updated to the RSRP value of the serving gNB after selecting or reselecting a new gNB. Secondly, it is updated to the new RSRP value, when terminal is moving closer to the cell center i.e., (RSRPrx−RSRPrxRef)>0. Thirdly, if the relaxed measurement criterion has not been met for search interval, the terminal device shall set the value of RSRPrxRef to the current RSRPrx value. Finally, RSRPSearchDeltaP is a parameter configured the terminal device to monitor the received signal variation. According to an embodiment the terminal device is further caused to receive, from the radio access network, a second threshold value, which is used by the terminal device to determine the relaxation state, when the RSRP measurement value is greater than the second threshold value. In this case, the RSRP measurement value is high enough and the terminal device may be considered to be located not at the cell edge. The terminal device compares the RSRP level versus the second threshold value as in Equation 2 According to an embodiment the terminal device may be further caused to receive a third threshold, which is used by the terminal device to determine relaxation state, when the reference signal received power (RSRP) measurement is essentially same than the previous RSRP measurement, within the limits defined by the third threshold. This criterion is used to determine actual stationarity of the terminal device.

The terminal device may be configured to monitor at least one of the RRM relaxation triggers. The network can configure the trigger to the terminal device independently (i.e., either low-mobility, or not-at-cell-edge, or both). In case the RRM relaxation is triggered with respect to its configuration the terminal device has to apply RRM measurement relaxation. The accuracy requirements for the first threshold and the second threshold for relaxation state detection may be set by the core network.

According to an embodiment the terminal device is further caused to provide an indication, to a core network, that the terminal device has paused or stopped providing positioning reports. The terminal device may keep on providing positioning reports to the core network, as dictated by the configuration, until the terminal device has detected relaxation state. The terminal device may indicate to the core network whether it has only paused providing positioning reports to the core network or if that stopped providing positioning reports. If the terminal device has indicated that it has paused providing the positioning report of the core network, the core network may store positioning session information to maintain the latest position information and to continue the positioning session once the terminal device has informed that the terminal device has resumed providing positioning reports. The indication/information of not providing report from the terminal device to the core network may be done e.g. using latest positioning reference signal measurements reports.

According to an embodiment the terminal device is further caused to receive, from the core network, information of a positioning timer in the core network. The timer in the core network is indicating time elapsed since latest positioning report from the terminal device. The terminal device may, being aware of the timer in the core network, pause PRS measurements when the relaxation state is detected and refrain from providing further positioning reports upon detecting the relaxation state. The core network may, once the timer value has expired, conclude that the terminal device has paused sending positioning reports.

According to an embodiment the terminal device further caused to provide, to the core network, when the terminal device has detected the relaxation state, information on the latest positioning reference signal PRS measurements and that the terminal device has paused or stopped providing positioning reports.

According to another embodiment, the terminal device is further caused to resume or re-start providing positioning reports to the core network, when the terminal device has detected that the relaxation state has ended. The terminal device may detect end of relaxation state for example, when the RSRP measurement value has changed more than the first threshold value when compared to the previous RSRP measurement, or when the RSRP measurement value is lower than the second threshold value.

According to another embodiment, there is an apparatus in the radio access network, an access node comprising at least one processor, and at least one memory including computer program code, wherein the at least one memory and the computer program code are configured, with the at least one processor, to cause the access node to receive information from a core network, to enable pausing or stopping of providing positioning reports of at least one terminal device when the at least one terminal device has detected relaxation state; and provide information to the core network element that the access node has enabled pausing or stopping of the at one least terminal device to provide positioning reports. The information to enable pausing or stopping of positioning reports of at least one terminal device may be provided by Radio Resource Control (RRC) message signalling.

According to another embodiment, there is an apparatus in the core network, the apparatus comprising at least one processor, and at least one memory including computer program code, wherein the at least one memory and the computer program code are configured, with the at least one processor, to cause the apparatus to receive information, from a terminal device, information on periodicity of radio resource management relaxation; or time interval of RSRP measurement of a serving cell or of a neighbouring cell; and to provide information, to the terminal device, to pause or stop providing positioning reports when the terminal device has detected relaxation state.

According to another embodiment, there is an apparatus in the core network, wherein the apparatus is further caused to store a positioning session information of the terminal device, when the terminal device provided information on pausing providing positioning reports.

According to another embodiment, there is an apparatus in the core network, wherein the apparatus is further caused to delete the positioning session information of the terminal device, when the terminal device provided information on stopping providing positioning reports.

According to another embodiment, there is an apparatus in the core network, wherein the apparatus is further caused to start a timer with an expiration value, when receiving positioning information from the terminal device; and when the timer has expired, the apparatus is further caused to store the positioning session information of the terminal device.

According to another embodiment, there is an apparatus in the core network, wherein the apparatus is further caused to stop/reset a timer value when receiving positioning information from the terminal device.

According to another embodiment, there is an apparatus in the core network, wherein the apparatus is further caused to transmit an indication to the access node to enable positioning pausing by the access node. The positioning pausing refers to pausing of providing positioning reports to the access node. The pausing of providing positioning reports saves energy of the terminal device.

According to another embodiment, there is an apparatus in the core network, wherein the apparatus is further caused to receive an indication from the access node acknowledging to enable positioning pausing by the access node.

According to another embodiment, there is an apparatus in the core network, wherein the apparatus is further caused to transmit an indication to terminal device enabling and disabling of positioning pausing after relaxation status detection.

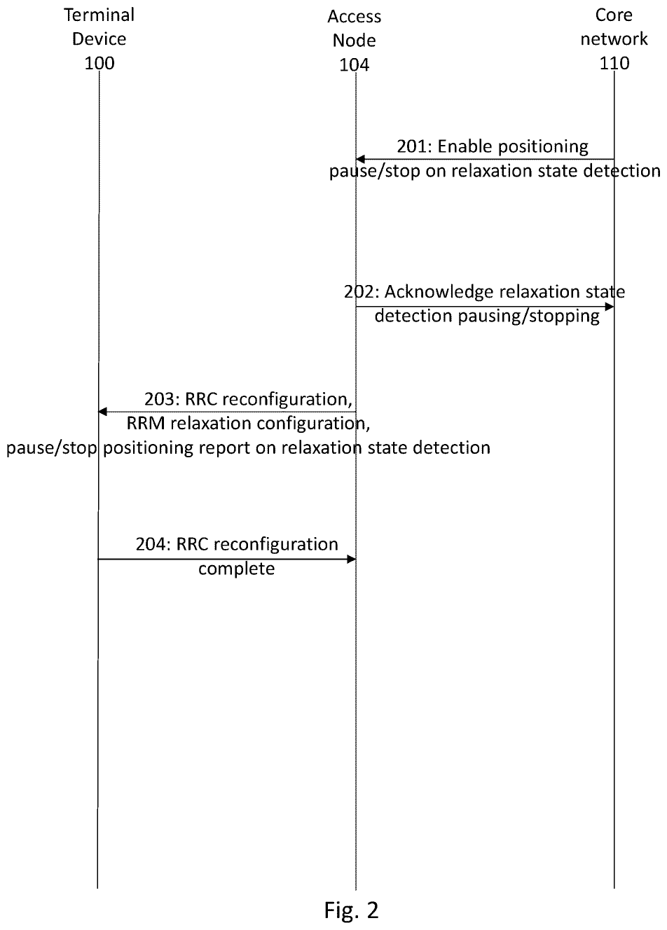

FIG. 2 illustrates a signalling diagram according to an exemplary embodiment. This exemplary embodiment may be used in configuration of the terminal device for stopping/pausing providing positioning reports. There are two alternatives for the configuration: 1) Configuration through the radio access network and 2) configuration through the core network.

Referring to FIG. 2, the configuration is done through the radio access network (Message sequence chart in FIG. 2).

In step 201 the core network 110 requests the access node 104 of the radio access network to enable stop or pause of providing positioning reporting in case the terminal device 100 has detected to be in relaxation state (The stationarity could be detected by the terminal device 100 or by the access node 104).

In step 202, the access node 104 may acknowledge the request by informing the core network 110 that it supports the stationarity detection procedure.

In step 203, the access node 104 becomes aware of terminal device's 100 positioning accuracy requirements from message in step 1 and may decide to configure the terminal device 100 to pause/stop providing positioning reports. In this example, this is configured to the terminal device 100 with an RRC Reconfiguration message.

In step 204, the terminal device 100 acknowledges the RRC reconfiguration completed.

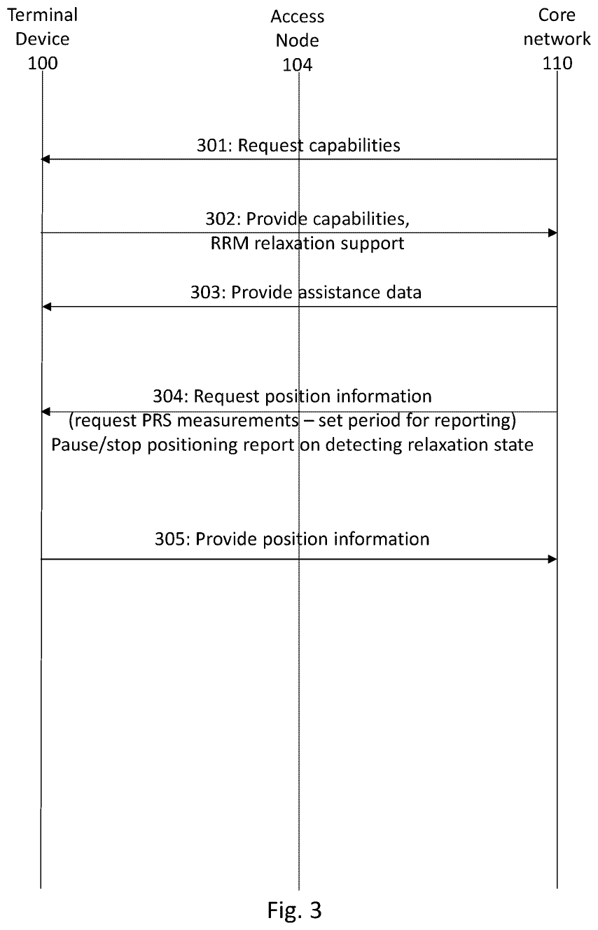

Referring to FIG. 3, the configuration is done through by the core network 110 (message sequence chart in FIG. 3).

In step 301 the core network 110 is requesting during the positioning setup procedure the terminal device 100 capabilities.

In step 302, the terminal device 100 answers with supported frequencies bands and positioning methods and the terminal device 100 also indicates RRM relaxation support.

In step 303, the core network 110 provides assistance data (e.g. where the terminal device 100 can measure PRS).

In step 304, the core network 110 requests location information, and it also requests the terminal device 100 to pause/stop providing positioning report on detection of relaxation state. In one alternative, the core network 110 may also indicate to the terminal device 100 whether it supports a timer approach to detect that the terminal device 100 has paused/stopped providing positioning report. In another alternative, the core network 100 may also indicate to the terminal device 100 that the terminal device 100 should send a last positioning report before the terminal 100 has paused/stopped providing positioning report on stationarity detection. The core network 110 sends positioning accuracy requirements to the terminal device 100. The pause of providing positioning reports is to be enabled if the threshold for RRM relaxation detection falls within accuracy requirements set by the core network 110.

In step 305, the terminal device 100 keeps on providing location information as dictated by the configuration.

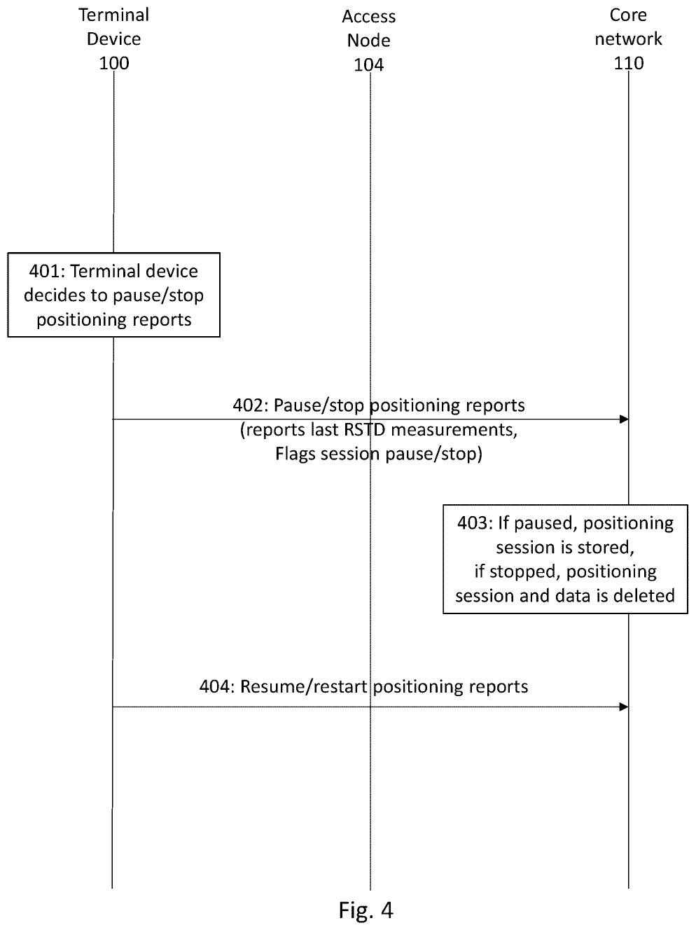

FIG. 4 illustrates the situation, when the core network 110 determines that the terminal device 100 has stopped/paused providing positioning report through a last positioning report (message sequence chart of FIG. 4.)

In step 401, the terminal device 100 decides to pause/stop providing positioning report to the core network 110.

In step 402, the terminal device 100 sends the last available RSTD reports. The terminal device 100 uses a flag to indicate whether the providing positioning report is paused or stopped. The pausing or stopping may be decided with respect to expected stationarity of the terminal device 100, by the terminal device 100.

In step 403, the core network 110 pauses the reporting session if the terminal device 100 decides to pause. The related context of the terminal device 100 is kept such that positioning session can be resumed using the same related terminal device context (for example, if stationarity i.e. relaxation state is no longer valid the core network 110 can resume the positioning process for this terminal device by skipping steps 301 to 304 (or at least steps 301 and 302) from FIG. 3, aiming at faster location estimation). If the terminal device 100 decides to stop providing positioning reports, the core network 110 flushes the related terminal device context (i.e., it deletes terminal device 100 specific data such as terminal device 100 capabilities).

In step 404, the terminal device 100 reports that it is no longer in relaxation state (i.e. non-stationary), and it report either to re-start or resume providing positioning reports.

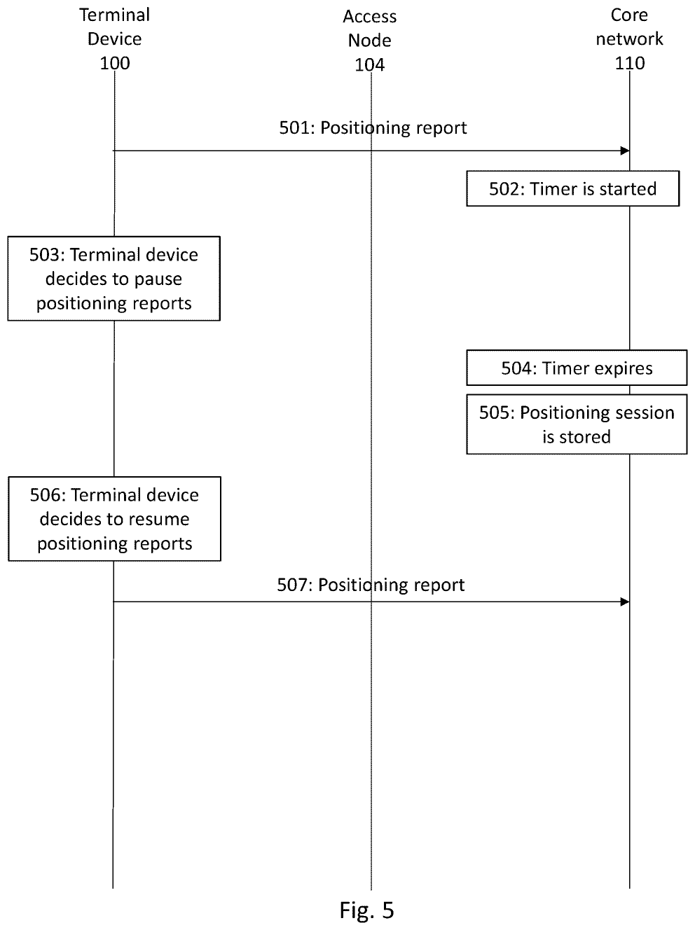

FIG. 5 illustrates the situation, when the core network 110 determines that the terminal device 100 has stopped/paused providing positioning report through a timer running at the core network 110 (Message sequence chart in FIG. 5.)

In step 501, the terminal device 100 provides the positioning report to the core network 110.

In step 502, with the reception of each positioning report the core network 110 re-starts the timer, which could be set according to the periodicity of the positioning reports.

In step 503, the terminal device 100 decides to pause providing positioning report to the core network on detection of relaxation state. The terminal device 100 decides not to send the last available RSTD reports as the terminal device 100 may be aware of the timer-based approach decided by the core network 110 and provided to the access node 104 and the terminal device 100 as part of the configuration phase.

In step 504, the timer at the core network 110 expires.

In step 505, the core network 110 pauses the reporting session. The terminal device 100 related context is stored such that positioning session can be resumed using the same terminal device 100 related context (for example, if stationarity i.e. relaxation state is no longer valid the core network 110 can resume the positioning process for this terminal device 100 by skipping steps 301 to 304 (or at least steps 301 and 302) from FIG. 3, aiming at faster location estimation).

In step 506, the terminal device 100 detects stationarity criteria i.e. relaxation criteria is not fulfilled anymore

In step 507, the terminal device 100 provides a positioning report which resumes the positioning procedure.

In all of the above embodiments, the terminal device, when stopping or pausing providing positioning report, may also stop or pause performing positioning measurements.

In case the terminal device decides to just stop or pause providing positioning report and still continue performing positioning measurements, the terminal device may detect-by other means, like a motion sensor-that it has actually moved in case where the RRM relaxation trigger is not working as expected. In such a case, the terminal device may decide to resume providing positioning reports.

This disclosure provides a more efficient terminal device positioning process in terms of energy saving. This is because the conditions to perform positioning measurements and reporting are adjusted with respect to the terminal device mobility. This is particularly beneficial for RedCap terminal device with strict requirement in terms of power saving. The signalling overhead from performing positioning measurements and reporting is reduced at both the UE and the network.

It will be obvious to a person skilled in the art that, as the technology advances, the inventive concept can be implemented in various ways. The invention and its embodiments are not limited to the examples described above but may vary within the scope of the claims.

1.-18. (canceled)

19. A terminal device comprising at least one processor, and at least one memory including computer program code, wherein the at least one memory and the computer program code are configured, with the at least one processor, to cause the terminal device to be configured to pause or stop providing positioning reports when a relaxation state is detected.

20. A terminal device according to claim 19, wherein the terminal device is further caused to receive, from a radio access network, a first threshold value, and further caused to determine the relaxation state, when a reference signal received power has changed less than the first threshold value.

21. A terminal device according to claim 19, wherein the terminal device is further caused to receive, from the radio access network, a second threshold value, and further caused to determine the relaxation state, when the reference signal received power is greater than the second threshold value.

22. A terminal device according to claim 19, wherein the terminal device is further caused to provide an indication to a core network, that the terminal device has paused or stopped providing positioning reports.

23. A terminal device according to claim 22, wherein the terminal device is further caused to provide an indication to a core network whether the terminal device has paused or stopped providing positioning reports.

24. A terminal device according to claim 19 wherein the terminal device is further caused to receive, from the core network, information of a positioning timer in the core network, and further caused to pause providing positioning reports when the relaxation state is detected.

25. A terminal device according to claim 19, wherein the terminal device is further caused to provide, to the core network, when the terminal device has detected the relaxation state, information that the terminal device has paused or stopped providing positioning reports.

26. A terminal device according to claim 24, wherein the information includes at least one latest positioning reference signal measurements report.

27. A terminal device according to claim19, wherein the terminal device is further caused to resume or re-start providing positioning reports and to provide information to the core network, when the terminal device has detected that the relaxation state has finished.

28. An access node in the radio access network, the access node comprising at least one processor, and at least one memory including computer program code, wherein the at least one memory and the computer program code are configured, with the at least one processor, to cause the access node to:
to receive information from a core network, to enable pausing or stopping of providing positioning reports of at least one terminal device when the at least one terminal device has detected that the at least one terminal device has detected a relaxation state; and
provide information to the core network element that the access node has enabled pausing or stopping of the at least terminal devices providing positioning reports.

29. An apparatus in the core network, the apparatus comprising at least one processor, and at least one memory including computer program code, wherein the at least one memory and the computer program code are configured, with the at least one processor, to cause the apparatus to:
receive information, from a terminal device, information on periodicity of radio resource management relaxation; or time interval of reference signal received power measurement of a serving cell or of a neighbouring cell; and
provide information, to the terminal device, to pause or stop positioning when the terminal device has detected relaxation state.

30. An apparatus according to claim 29, wherein the apparatus is further caused to store a positioning session information of the terminal device, when the terminal device provided information on pausing providing positioning reports.

31. An apparatus according to claim 30, wherein the apparatus is further caused to delete the positioning session information of the terminal device, when the terminal device provided information on stopping providing positioning reports.

32. An apparatus according to claim 29, wherein the apparatus is further caused to start a timer with an expiration value, when receiving positioning information from the terminal device; and when the timer has expired, the apparatus is further caused to store the positioning session information of the terminal device.

33. An apparatus according to claim 29, wherein the apparatus is further caused to stop/reset a timer value when receiving positioning information from the terminal device.

34. An apparatus according to claim 29, wherein the apparatus is further caused to transmit an indication to the access node to enable positioning pausing by the access node.

35. An apparatus according to claim 29, wherein the apparatus is further caused to receive an indication from the access node acknowledging to enable positioning pausing by the RAN node.

36. An apparatus according to claim 29, wherein the apparatus is further caused to transmit an indication to the terminal device enabling and disabling of positioning pausing after relaxation status detection.
